(19) United States
(12) Patent Application Publication
(10) Pub. No.: US 2011/0035147 A1
(43) Pub. Date: Feb. 10, 2011

(54) METHOD OF DETERMINING VEHICLE ROUTE AND NAVIGATION SYSTEM

(75) Inventor: Masato KIMISHIMA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/818,626

(22) Filed: Jun. 18, 2010

(30) Foreign Application Priority Data
Aug. 10, 2009 (JP) 2009-185940

(51) Int. Cl. G01C 21/36; G01S 19/42

(52) U.S. Cl. 701/201

(57) ABSTRACT

A method of determining a vehicle route includes the steps of calculating a current location; memorizing ramp section definition information, a main road route tilt attribute, and a bifurcation route tilt attribute, per ramp section; ramp section determining whether or not the current location of an own vehicle is in the ramp section based on the current location information; detecting pitch angle rate information, which is tilt change in a traveling direction of the own vehicle, by a sensor; determining a tilt attribute of a driving route by sampling the pitch angle rate information in a predetermined sampling period for integration; defining a table for a route determination result corresponding to the tilt attribute determined by the tilt attribute determination step, the main road route tilt attribute, and the bifurcation route tilt attribute; and determining a vehicle route to obtain the route determination result referring to the table.

### BACKGROUND OF THE INVENTION

1. Field of the Invention

The present invention relates to a method of determining a vehicle route and a navigation system that are capable of determining, regarding roads with little horizontal displacement, such as a main road of an expressway and a bifurcation route to a vehicle exit gate therefrom, for example, on which road the vehicle is driving at low cost with high accuracy.

2. Description of the Related Art

Navigation systems in the past are sometimes not able to accurately determine, regarding a main road of an expressway and a road bifurcated to a vehicle exit gate therefrom, for example, whether a vehicle is passing through the main road of the expressway or has entered into the road bifurcated to a vehicle exit gate.

Particularly in expressways in urban areas, horizontal displacement in bifurcation roads bifurcated from main roads to vehicle exit gates is little, and a structure of running a main road and a bifurcation road bifurcated to a vehicle exit gate in parallel overlapping vertically or a structure of running them closely is often employed.

On such roads having a structure, with little horizontal displacement, of running a main road and a bifurcation road bifurcated from the main road in parallel overlapping vertically or a structure of running a main road and a bifurcation road bifurcated from the main road closely, it is desired to quickly determine which road the vehicle is driving.

This is because, in a case that a current location of a vehicle being route guided goes out of a guided route, quick and accurate correction of the guided route is desired.

In such a structure, with little horizontal displacement, of running a main road and a bifurcation road bifurcated from the main road in parallel overlapping vertically, a current location of a driving vehicle is estimated as follows.

That is, vertical displacement of the vehicle, i.e., a three dimensional driving track including an amount of vertical displacement and an estimated current location are calculated from data obtained from an orientation sensor, a vehicle speed sensor, and a vertical displacement sensor, and the three dimensional driving track and the estimated current location thus calculated are memorized in a driving track memory unit.

Proposed is what then identifies the road on which a vehicle has been driven in a road identification unit from a degree of matching between map data memorized in a map data memory unit and the three dimensional driving track and the estimated current location of a vehicle memorized in the driving track memory unit (refer to Japanese Unexamined Patent Application Publication No. 2003-194558).

### SUMMARY OF THE INVENTION

Accordingly, such a method of determining a vehicle route and a navigation system in the past, in a case of memorizing vertical displacement data, determine the road in which the vertical displacement data of the three dimensional driving track of the vehicle most matches vertical displacement data corresponding to road data as a road currently driving on.

In a case of not memorizing the vertical displacement data, whether or not a vehicle is currently located at an identifiable location after driving is determined. In a case of determining as being in an identifiable location, a driving track in the opposite direction and a road network shape connected in the opposite direction are compared with reference to the point to identify the road on which the vehicle has been driving from a combination of road networks that matches best.

Consequently, it takes processing time to identify the road currently driving on and it has been difficult to quickly cope with such a situation that has to be determined immediately.

It is thus desirable to provide a method of determining a vehicle route and a navigation system that are capable of identifying the road driving on quickly and accurately.

According to an embodiment of the present invention, a method of determining a vehicle route includes the steps of: calculating a current location to calculate current location information including a latitude and a longitude of a receiving location based on signals from a plurality of GPS satellites; memorizing ramp section definition information to define a ramp section having a bifurcation structure including both a main road route and a bifurcation route bifurcated from the main road route, a main road route tilt attribute representing whether the main road route in the ramp section is upwardly inclined, downwardly inclined, or horizontal, and a bifurcation route tilt attribute representing whether the bifurcation route in the ramp section is upwardly inclined, downwardly inclined, or horizontal in a memory unit, for every ramp section; ramp section determining whether or not the current location of an own vehicle has entered into the ramp section based on the current location information calculated in the current location calculation step; detecting pitch angle rate information, which is a change in tilt in front and rear in a direction of travel of the own vehicle, by a sensor; determining a tilt attribute of a route on which the own vehicle is driving to be whether upwardly inclined, downwardly inclined, or horizontal by sampling the pitch angle rate information detected by the sensor in the pitch angle rate information detection step in a predetermined sampling period for integration; table defining to define, as a table, a route determination result of the route on which the own vehicle is driving to be whether the main road route or the bifurcation route in correspondence with the tilt attribute of where the own vehicle is driving determined by the tilt attribute determination step, the main road route tilt attribute in the ramp section, and the bifurcation route tilt attribute in the ramp section; and determining a vehicle route to obtain the route determination result of whether the route on which the own vehicle is driving is the main road route or the bifurcation route with reference to the table based on the main road route tilt attribute regarding the main road route read out from the memory unit for the ramp section determined by the ramp section determination step, the bifurcation route tilt attribute regarding the bifurcation route read out from the memory unit for the ramp section, and the tilt attribute of where the own vehicle is driving determined by the tilt attribute determination step.

According to another embodiment of the present invention, a navigation system includes: a GPS process unit calculating current location information including a latitude and a longitude of a receiving location based on signals from a plurality of GPS satellites; a memory unit memorizing ramp section definition information to define a ramp section having a bifurcation structure including both a main road route and a bifurcation route bifurcated from the main road route, a main road route tilt attribute representing whether the main road route in the ramp section is upwardly inclined, downwardly inclined, or horizontal, and a bifurcation route tilt attribute representing whether the bifurcation route in the ramp section is upwardly inclined, downwardly inclined, or horizontal, for every ramp section; ramp section determination means for determining whether or not a current location of an own vehicle has entered into the ramp section based on the current location information calculated by the GPS process unit; a sensor outputting pitch angle rate information, which is a change in tilt in front and rear in a direction of travel of the own vehicle; tilt attribute determination means for determining a tilt attribute of a route on which the own vehicle is driving to be whether upwardly inclined, downwardly inclined, or horizontal by detecting the pitch angle rate information outputted from the sensor in a predetermined sampling period for moving average; a table defining a route determination result of the route on which the own vehicle is driving to be whether the main road route or the bifurcation route in correspondence with the tilt attribute of where the own vehicle is driving determined by the tilt attribute determination means, the main road route tilt attribute in the ramp section, and the bifurcation route tilt attribute in the ramp section; and vehicle route determination means for obtaining the route determination result of whether the route on which the own vehicle is driving is the main road route or the bifurcation route with reference to the table based on the main road route tilt attribute regarding the main road route read out from the memory unit in the ramp section determined by the ramp section determination means, the bifurcation route tilt attribute regarding the bifurcation route read out from the memory unit in the ramp section, and the tilt attribute of where the own vehicle is driving determined by the tilt attribute determination means.

According to embodiments of the present invention, there is an effect to be capable of providing a method of determining a vehicle route and a navigation system that are capable of identifying a road currently driving on quickly and accurately.

### BRIEF DESCRIPTION OF THE DRAWINGS

FIG. 1 is a functional block diagram illustrating the configuration of a vehicle route determination system to which a method of determining a vehicle route according to an embodiment of the present invention is applied;

FIG. 2 illustrates a coordinate system in a navigation system according to the embodiment of the present invention;

FIG. 3 is a flowchart showing behaviors of the navigation system according to the embodiment of the present invention; and

FIG. 4 shows contents of a table in the navigation system according to the embodiment of the present invention.

### DESCRIPTION OF THE PREFERRED EMBODIMENTS

### Embodiment

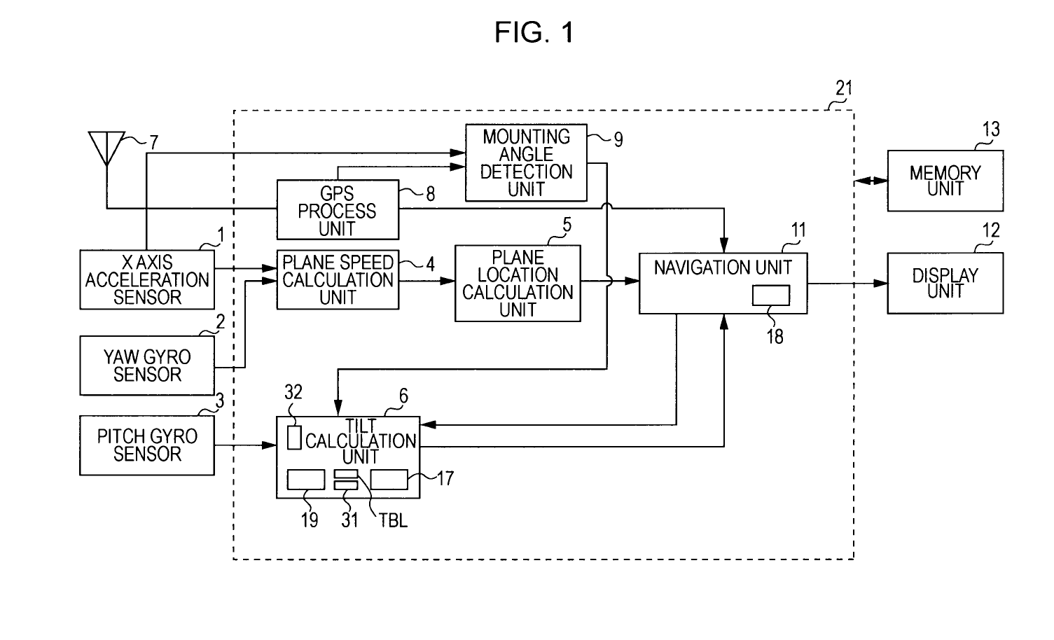

FIG. 1 is a functional block diagram illustrating the configuration of a navigation system to which a method of determining a vehicle route according to an embodiment of the present invention is applied.

Such a navigation system 30 is configured to include an X axis acceleration sensor 1, a yaw gyro sensor 2, a pitch gyro sensor 3, a plane speed calculation unit 4, a plane location calculation unit 5, a tilt calculation unit 6, an antenna 7, a GPS process unit 8, a mounting angle detection unit 9, and a navigation unit 11. In addition, the navigation system 30 is further provided with a memory unit 13 and a display unit 12.

These configuration components and configuration members, such as the X axis acceleration sensor 1, are held in a housing 32.

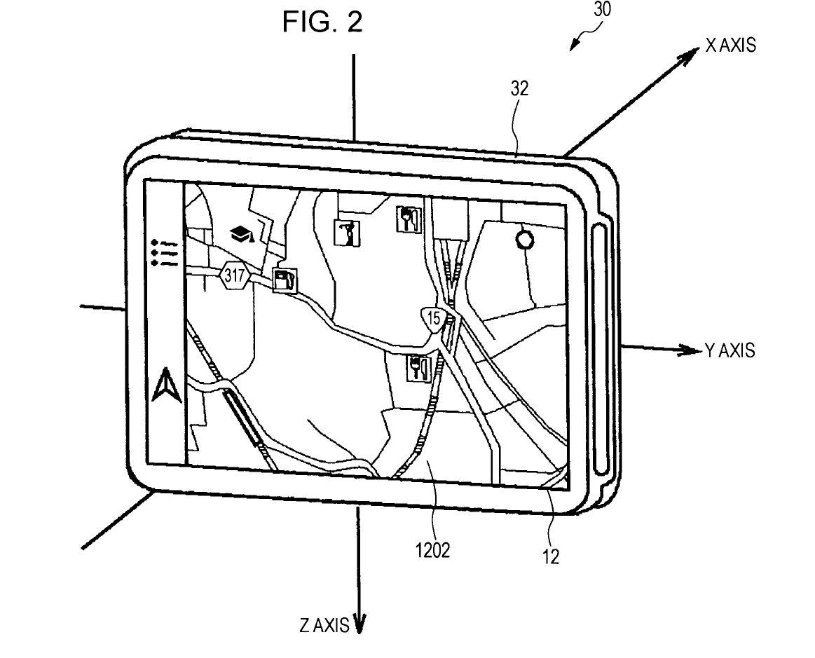

As illustrated in FIG. 2, the housing 32 appears in the shape of a rectangular plate.

The display unit 12 is equipped with a display screen 1202 so as to occupy almost the entire area of one of the surfaces in the thickness direction of the housing 32.

The housing 32 is mounted in an appropriate area in a vehicle interior, such as a dashboard, via a mounting member, not shown, in such a manner that the display screen 1202 is at an angle easily seen from a driver.

The display unit 12 is configured with, for example, a liquid crystal display that displays a current location, map data including the current location, route guidance marks, operation icons, and the like on the display screen 1202.

Here, when an axis perpendicular to the display screen 1202 is defined as an X axis, an angle (deviation angle) made by the X axis and a direction of a vehicle going straight ahead is defined as an angle of mounting the navigation system 30.

In addition, an axis perpendicular to the X axis and extending horizontally is defined as a Y axis, and an axis perpendicular to both the X axis and the Y axis and extending vertically is defined as a Z axis.

The X axis acceleration sensor 1 is a sensor detecting acceleration information in a direction of travel when the navigation system 30 travels.

The yaw gyro sensor 2 is a sensor utilizing a gyroscope that detects orientation angle information of a direction of travel of the vehicle.

The pitch gyro sensor 3 is a sensor utilizing a gyroscope that detects a pitch angle rate, which is a change in tilt in front and rear in a direction of travel of the vehicle.

The plane speed calculation unit 4 calculates speed of the vehicle on the X-Y plane defined by the X axis and the Y axis in FIG. 2 based on the acceleration information in the direction of travel detected by the X axis acceleration sensor 1 and the orientation angle information in the direction of travel of the vehicle detected by the yaw gyro sensor 2.

The plane location calculation unit 5 calculates a current location on map data of the vehicle based on the speed of the vehicle on the X-Y plane calculated by the plane speed calculation unit 4.

The tilt calculation unit 6 calculates a tilt angle of the vehicle, i.e., a tilt angle of a road on which the vehicle is driving based on pitch angle rate information, which is the tilt in front and rear of the vehicle detected by the pitch gyro sensor 3.

The navigation system 30 is mounted on a dashboard of a driver's seat at a desired mounting angle in such a manner that the display screen 1202 of the display unit 12 is directed towards the driver in the driver's seat. Consequently, the X axis of the navigation system 30 often does not match with the direction of the vehicle going straight ahead.

Accordingly, it is desired to correct the pitch angle rate detected by the pitch gyro sensor 3 with the mounting angle.

Consequently, the tilt calculation unit 6 corrects the pitch angle rate detected by the pitch gyro sensor 3 using the mounting angle of the navigation system 30 detected by the mounting angle detection unit 9 described later.

That is, the tilt calculation unit 6 is provided with a pitch angle correction mechanism 17 that corrects the pitch angle rate detected by the pitch gyro sensor 3 in accordance with the angle of mounting the navigation system 30 main body with reference to the direction of the own vehicle going straight ahead.

In addition, the tilt calculation unit 6 is provided with an offset elimination circuit 19 that eliminates offset of the pitch angle rate detected by the pitch gyro sensor 3.

The pitch angle in the tilt calculation unit 6 is calculated by moving averaging or integrating a pitch angle rate signal, which is detected in a predetermined sampling period and is tilt in front and rear of the vehicle outputted from the pitch gyro sensor 3.

As the moving average value or the integrated value exceeds a certain threshold, the inclination of the road is determined as upward inclination “UP” or downward inclination “DOWN”.

The certain threshold in a case of determining the inclination of the road as upward inclination “UP” is defined as an up threshold, and the certain threshold in a case of determining the inclination of the road as downward inclination “DOWN” is defined as a down threshold.

The elimination of offset of a pitch angle rate in the offset elimination circuit 19 is carried out as follows.

When a vehicle is in a horizontal state, the pitch angle rate information is normally at 0° (degrees) that is the tilt in front and rear of the vehicle detected by the pitch gyro sensor 3.

However, the pitch angle rate information sometimes does not become 0° and offset may be outputted even when the vehicle is in a horizontal state due to characteristics of sensor circuits including the pitch gyro sensor 3, and further the amount of the offset varies in accordance with an ambient temperature.

Such temperature drift of the offset of the sensor circuits including the pitch gyro sensor 3 is compensated by specifying the temperature characteristics of the sensor circuits including the pitch gyro sensor 3 in advance and being equipped with a temperature compensation circuit of opposite characteristics from the specified temperature characteristics.

The pitch angle rate information detected by the pitch gyro sensor 3 includes offset due to a change in gravitational acceleration that acts on the pitch gyro sensor 3 in accordance with whether the vehicle is driven on a road of upward inclination or a road of downward inclination.

That is, the gravitational acceleration becomes larger that acts on the pitch gyro sensor 3 when the vehicle is driven on a road of upward inclination, and the gravitational acceleration becomes smaller that acts on the pitch gyro sensor 3 when the vehicle is driven on a road of downward inclination.

Consequently, when the vehicle is driven on a road of upward inclination, the offset due to an increase of the gravitational acceleration acting on the pitch gyro sensor 3 is included in the pitch angle rate information.

When the vehicle is driven on a road of downward inclination, the offset due to a decrease of the gravitational acceleration acting on the pitch gyro sensor 3 is included in the pitch angle rate information.

Accordingly, a value learned from the measured values of the pitch gyro sensor 3 for a relatively long period, for example, over the past tens of seconds is defined as a learned offset amount.

This reduces the amount of offset due to a change in the gravitational acceleration acting on the pitch gyro sensor 3 that is expressed for a short period and the amount of offset generated due to the characteristics of the sensor circuits including the pitch gyro sensor 3.

Then, based on the pitch angle rate information detected by the pitch gyro sensor 3 in which the learned offset amount is eliminated, a pitch angle rate signal is integrated, which is the tilt in front and rear of the vehicle, in a sampling period after entering into a link section of a ramp or near a bifurcation point of a bifurcation road to a ramp.

In addition, the tilt calculation unit 6 is provided with a table TBL, a tilt attribute determination mechanism 31, and a vehicle route determination mechanism 32.

The tilt attribute determination mechanism 31 detects the pitch angle information outputted from the pitch gyro sensor 3 in a predetermined sampling period for moving average, thereby determining whether a tilt attribute 103 of a route on which the own vehicle is driving is upwardly inclined, downwardly inclined, or horizontal.

The vehicle route determination mechanism 32 refers to the table TBL, as the own vehicle is driving in a ramp section of an expressway, based on a bifurcation route tilt attribute 101 and a main road route tilt attribute 102 set for every ramp section and also the tilt attribute 103 determined by the tilt attribute determination mechanism 31.

Then, the vehicle route determination mechanism 32 identifies whether the road on which the vehicle is currently driving is a main road of an expressway, another road, or a bifurcation road (ramp) to an entrance or exit gate with high accuracy.

The antenna 7 receives signals from a plurality of GPS satellites in the sky.

The GPS process unit 8 calculates current location information including the latitude and the longitude of the receiving location based on the signals from the plurality of GPS satellites received by the antenna 7.

The mounting angle detection unit 9 detects the angle of mounting the navigation system 30 to output to the tilt calculation unit 6.

This mounting angle is calculated from a difference of speed information of the vehicle calculated based on the signals received from the GPS satellites from speed information calculated from the acceleration information detected by the X axis acceleration sensor 1 of the navigation system 30 mounted at the mounting angle described above.

The navigation unit 11 is provided with a ramp section determination mechanism 18 that determines whether or not the current location of the own vehicle has entered into a ramp section of an expressway based on the current location information calculated by the GPS process unit 8.

Here, the ramp section is defined as an area having a bifurcation structure including both a main road route and a bifurcation route bifurcated from the main road route.

The navigation unit 11 displays the current location of the own vehicle on the map data based on the current location information including the latitude and the longitude of the receiving location calculated by the GPS process unit 8 or the current location information of the vehicle on the map data calculated by the plane location calculation unit 5.

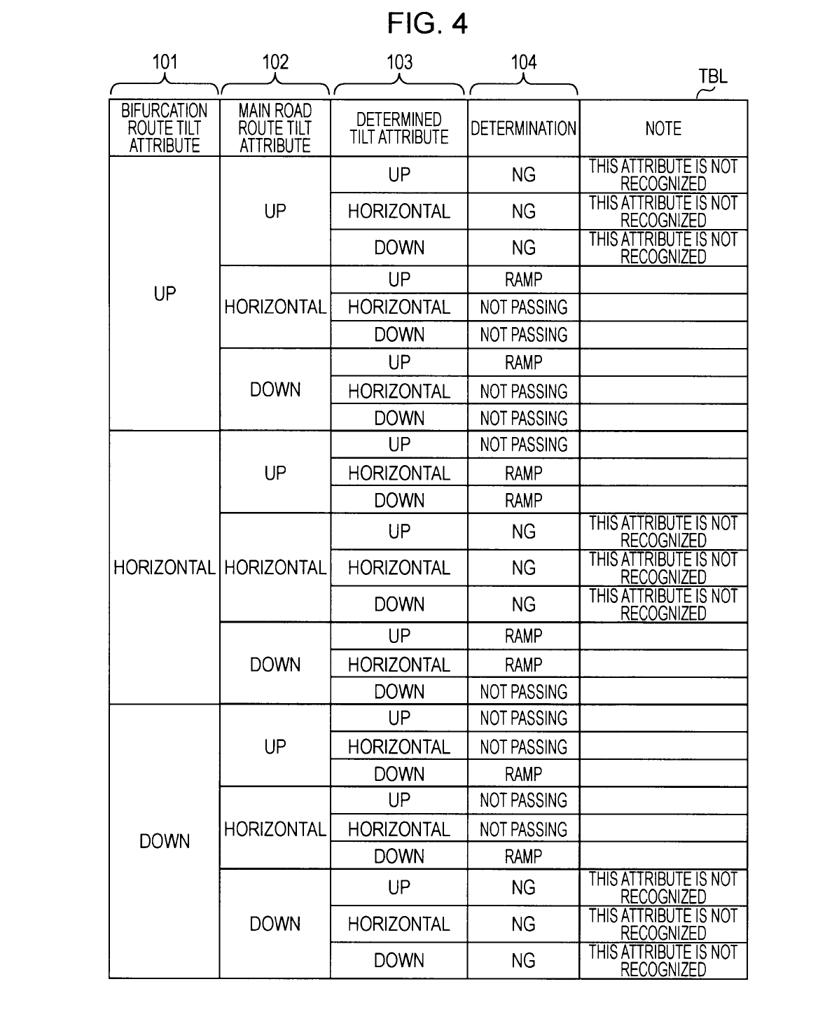

FIG. 4 illustrates the contents of the table TBL included in the tilt calculation unit 6 of the navigation system 30 according to this embodiment.

Expressways are provided with entrance gates to enter from an open road into an expressway and exit gates to get off from an expressway on an open road at predetermined spots.

In order to pass through such an entrance gate or an exit gate, a vehicle is driven on a bifurcation road bifurcated from a main road of the expressway. There are also cases of providing a bifurcation road to transfer to another expressway line.

At a bifurcation point for altering a course from a main road of an expressway to such a bifurcation road, since the driving speed in a main road of an expressway is fast, an approach angle to a bifurcation road relative to a main road of an expressway is designed to be narrow so as to allow a steering angle upon transferring from a main road of an expressway to a bifurcation road to be smaller.

In addition, a structure of ascending or descending with a vertically large inclination is often employed for such a bifurcation road bifurcated from a main road of an expressway after being bifurcated from a main road of an expressway.

Consequently, the bifurcation route tilt attribute 101 is set in the table TBL to show, for every bifurcation road (ramp) on the map data, whether the inclination of the bifurcation road is upward inclination “UP”, downward inclination “DOWN”, or horizontal “HORIZONTAL”.

Further, the main road route tilt attribute 102 is set that shows whether the inclination of the main road of the expressway near the bifurcation point in which the bifurcation road is bifurcated is upward inclination “UP”, downward inclination “DOWN”, or horizontal “HORIZONTAL”.

The bifurcation route tilt attribute 101 and the main road route tilt attribute 102 are information that is explicit in advance as the respectively corresponding tilt attribute for every bifurcation road (ramp) of expressways on the map data.

The bifurcation route tilt attribute 101 and the main road route tilt attribute 102 are memorized in the memory unit 13 for every bifurcation road (ramp) of expressways in the map data in correspondence, respectively.

Further, corresponding to the bifurcation route tilt attribute 101 and the main road route tilt attribute 102, the tilt attribute 103 is set in the table TBL as reference data to determine the inclination of the road driving on.

The tilt attribute 103 to determine the inclination of the road driving on is attribute information regarding the inclination of the road driving on obtained from the tilt angle of the vehicle calculated by integration in the tilt calculation unit 6 based on the pitch angle rate information detected by the pitch gyro sensor 3.

That is, the tilt attribute 103 is set in the table TBL as reference data corresponding to the bifurcation route tilt attribute 101 and the main road route tilt attribute 102.

Further, a determination result 104 is set regarding the road currently driving on that is determined uniquely corresponding to the bifurcation route tilt attribute 101, the main road route tilt attribute 102, and the tilt attribute 103.

The determination result 104 is classified as one of three types of NG (indeterminable), ramp (driving on a bifurcation road), and not passing (driving on a main road).

Combinations of the bifurcation route tilt attribute 101, the main road route tilt attribute 102, and the tilt attribute 103 are limited to 27 types as shown in FIG. 4.

Consequently, from a combination of the bifurcation route tilt attribute 101, the main road route tilt attribute 102, and the tilt attribute 103, the determination result 104 regarding the road currently driving on is obtained immediately by referring to the table TBL.

Here, a description is given to the determination result 104 set as the table TBL in correspondence with the bifurcation route tilt attribute 101, the main road route tilt attribute 102, and the tilt attribute 103 determined in the tilt calculation unit 6.

In FIG. 4, in a case of the bifurcation route tilt attribute 101 being upwardly inclined “UP” and the main road route tilt attribute 102 being upwardly inclined “UP” similarly, the determination result 104 regarding the road currently driving on is not obtained to turn out to be NG.

In this case, regardless of whether the determined tilt attribute 103 is upwardly inclined “UP”, horizontal “HORIZONTAL”, or downwardly inclined “DOWN”, the determination result 104 regarding the road currently driving on is not obtained to turn out to be NG.

This is because both the bifurcation route tilt attribute 101 and the main road route tilt attribute 102 are upwardly inclined “UP”, and since the determination is made by the attributes of the inclination, it becomes indeterminable.

Next, in a case of the bifurcation route tilt attribute 101 being upwardly inclined “UP” and the main road route tilt attribute 102 being horizontal “HORIZONTAL”, and when the determined tilt attribute 103 is upwardly inclined “UP”, the determination result 104 becomes ramp (driving on a bifurcation road).

In addition, in both cases of the determined tilt attribute 103 being horizontal “HORIZONTAL” and being downwardly inclined “DOWN”, the determination result 104 becomes not passing (driving on a main road).

Next, in a case of the bifurcation route tilt attribute 101 being upwardly inclined “UP” and the main road route tilt attribute 102 being downwardly inclined “DOWN”, and when the determined tilt attribute 103 is upwardly inclined “UP”, the determination result 104 becomes ramp (driving on a bifurcation road).

In addition, in both cases of the determined tilt attribute 103 being horizontal “HORIZONTAL” and being downwardly inclined “DOWN”, the determination result 104 becomes not passing (driving on a main road).

Next, in a case of the bifurcation route tilt attribute 101 being horizontal “HORIZONTAL” and the main road route tilt attribute 102 being upwardly inclined “UP”, and when the determined tilt attribute 103 is upwardly inclined “UP”, the determination result 104 becomes not passing (driving on a main road).

In addition, in both cases of the determined tilt attribute 103 being horizontal “HORIZONTAL” and being downwardly inclined “DOWN”, the determination result 104 becomes ramp (driving on a bifurcation road).

Next, in a case that both the bifurcation route tilt attribute 101 and the main road route tilt attribute 102 are horizontal “HORIZONTAL”, the determination result 104 regarding the road currently driving on is not obtained to turn out to be NG.

In this case, regardless of whether the determined tilt attribute 103 is upwardly inclined “UP”, horizontal “HORIZONTAL”, or downwardly inclined “DOWN”, the determination result 104 regarding the road currently driving on is not obtained to turn out to be NG.

This is because both the bifurcation route tilt attribute 101 and the main road route tilt attribute 102 are horizontal “HORIZONTAL”, and since the determination is made by the attributes of the inclination, it becomes indeterminable.

Next, in a case of the bifurcation route tilt attribute 101 being horizontal “HORIZONTAL” and the main road route tilt attribute 102 being downwardly inclined “DOWN”, and when the determined tilt attribute 103 is upwardly inclined “UP” or horizontal “HORIZONTAL”, either determination result 104 becomes ramp (driving on a bifurcation road).

Next, in a case of the bifurcation route tilt attribute 101 being horizontal “HORIZONTAL” and the main road route tilt attribute 102 being downwardly inclined “DOWN”, and when the determined tilt attribute 103 is downwardly inclined “DOWN”, the determination result 104 becomes not passing (driving on a main road).

Next, in a case of the bifurcation route tilt attribute 101 being downwardly inclined “DOWN” and the main road route tilt attribute 102 being upwardly inclined “UP”, and when the determined tilt attribute 103 is upwardly inclined “UP” or horizontal “HORIZONTAL”, either determination result 104 becomes not passing (driving on a main road).

In addition, when the determined tilt attribute 103 is downwardly inclined “DOWN”, the determination result 104 becomes ramp (driving on a bifurcation road).

Next, in a case of the bifurcation route tilt attribute 101 being downwardly inclined “DOWN” and the main road route tilt attribute 102 being horizontal “HORIZONTAL”, and when the determined tilt attribute 103 is upwardly inclined “UP” or horizontal “HORIZONTAL”, either determination result 104 becomes not passing (driving on a main road).

In addition, when the determined tilt attribute 103 is downwardly inclined “DOWN”, the determination result 104 becomes ramp (driving on a bifurcation road).

Next, in a case that both the bifurcation route tilt attribute 101 and the main road route tilt attribute 102 are downwardly inclined “DOWN”, the determination result 104 regarding the road currently driving on is not obtained to turn out to be NG. In this case, regardless of whether the determined tilt attribute 103 is upwardly inclined “UP”, horizontal “HORIZONTAL”, or downwardly inclined “DOWN”, the determination result 104 regarding the road currently driving on is not obtained to turn out to be NG.

This is because both the bifurcation route tilt attribute 101 and the main road route tilt attribute 102 are downwardly inclined “DOWN”, and since the determination is made by the attributes of the inclination, it becomes indeterminable.

The memory unit 13 is configured with memories including a RAM, a ROM, a harddisk, and the like. Map data is memorized in the memory unit 13.

In addition, in the memory unit 13, the bifurcation route tilt attribute 101 for each bifurcation road (ramp) in expressways in the map data and the main road route tilt attribute 102 of a main road of an expressway in parallel with the bifurcation road are memorized for every bifurcation road (ramp) in correspondence, respectively.

In addition, in the memory unit 13, ramp section definition data is memorized for every bifurcation road (ramp) in order to determine whether or not the current location of the own vehicle has entered into a ramp section, which is a bifurcation road (ramp) vicinity area of an expressway on the map data.

The reference numeral 21 shown in FIG. 1 denotes a data processing unit including the plane speed calculation unit 4, the plane location calculation unit 5, the tilt calculation unit 6, the GPS process unit 8, the mounting angle detection unit 9, and the navigation unit 11.

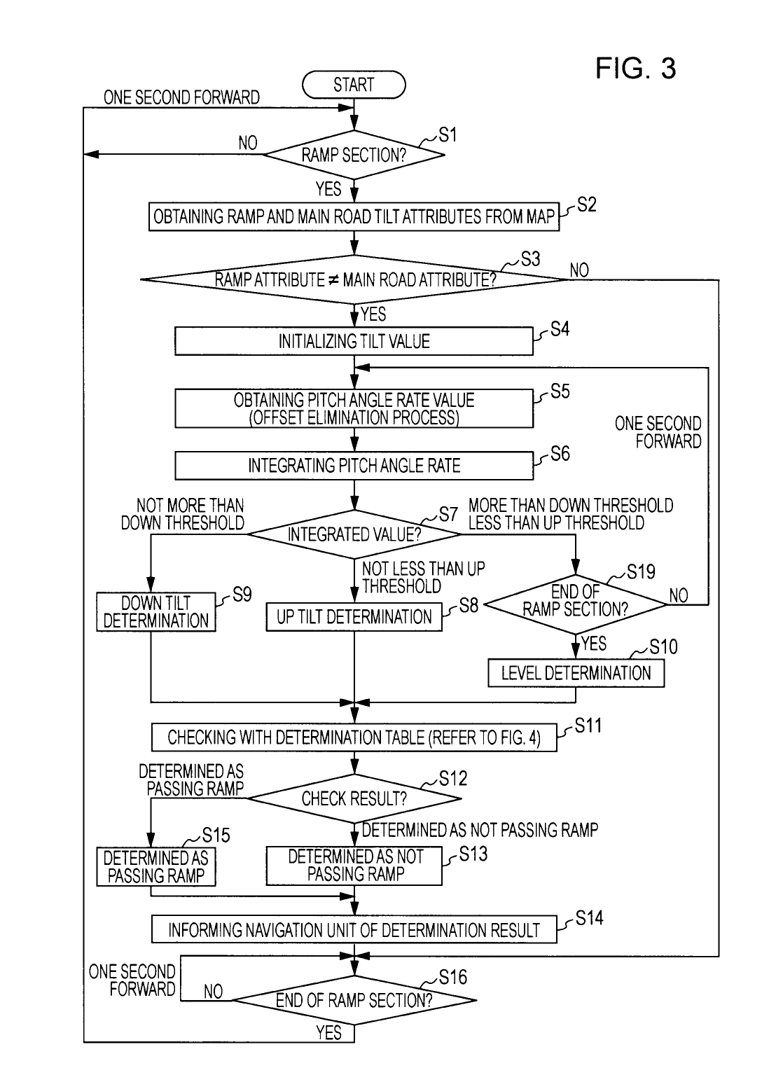

FIG. 3 is a flowchart showing behaviors of the navigation system 30 according to this embodiment.

The behaviors of the navigation system 30 of this embodiment are provided with a current location calculation step in which the GPS process unit 8 calculates current location information including the latitude and the longitude of a receiving location based on signals from the plurality of GPS satellites.

The behaviors are also provided with a memory step that memorizes ramp section definition information, a main road route tilt attribute, and a bifurcation route tilt attribute in the memory unit 13 for every ramp section.

Here, the ramp section definition information is information that defines a ramp section having a bifurcation structure including both a main road route and a bifurcation route bifurcated from the main road route.

The main road route tilt attribute is an attribute that represents whether a main road route in a ramp section is upwardly inclined, downwardly inclined, or horizontal.

The bifurcation route tilt attribute is an attribute that represents whether a bifurcation route in a ramp section is upwardly inclined, downwardly inclined, or horizontal.

The behaviors are also provided with a ramp section determination step in which the ramp section determination mechanism 18 of the navigation unit 11 determines whether or not a current location of the own vehicle has entered into a ramp section based on the current location information calculated in the current location calculation step.

The behaviors are also provided with a pitch angle information detection step in which the pitch gyro sensor 3 detects pitch angle rate information, which is tilt in front and rear in a direction of travel of the own vehicle.

The behaviors are also provided with a tilt attribute determination step in which the tilt attribute determination mechanism 31 determines a tilt attribute of a route on which the own vehicle is driven by sampling the pitch angle rate information detected by the pitch gyro sensor 3 in the pitch angle information detection step in a predetermined sampling period for moving average or integration.

The behaviors are also provided with a table definition step that defines a route determination result of a route on which the own vehicle is driven as the table TBL in correspondence with the tilt attribute 103, the main road route tilt attribute 102 in a ramp section, and the bifurcation route tilt attribute 101 in a ramp section.

The behaviors are also provided with a vehicle route determination step in which the vehicle route determination mechanism 32 obtains a route determination result of the own vehicle with reference to the table TBL based on the main road route tilt attribute 102, the bifurcation route tilt attribute 101, and the tilt attribute 103.

Here, the main road route tilt attribute 102 and the bifurcation route tilt attribute 101 are read out from the memory unit 13 regarding a ramp section and the tilt attribute 103 is determined by the tilt attribute determination step.

A description is given below to the behaviors with reference to the flowchart shown in FIG. 3.

Firstly, whether or not a driving vehicle is in the vicinity of a ramp section is determined (step S1).

The determination of whether or not to be in the vicinity of a ramp section is carried out as follows.

That is, it is carried out by determining whether or not the current location of the own vehicle has entered into a range (that is, ramp section) defined by the ramp section definition data of an expressway on map data from the map data and the ramp section definition data memorized in the memory unit 13 and the current location of the own vehicle.

As the current location of the own vehicle is determined to be in a ramp section, the bifurcation route tilt attribute 101 of a bifurcation road (ramp) in the ramp section and the main road route tilt attribute 102 of a main road of an expressway from which the bifurcation road in the ramp section is bifurcated are read out from the memory unit 13 (step S2).

The tilt attributes of the bifurcation route tilt attribute 101 and the main road route tilt attribute 102 are set with reference to an up threshold and a down threshold in order to determine upward inclination and downward inclination.

That is, upward inclination “UP” is set in a case of having inclination over the up threshold and downward inclination “DOWN” is set in a case of having inclination below the down threshold. The tilt attributes are thus set in advance for every bifurcation road (ramp), such as to be horizontal “HORIZONTAL” in a case of having inclination in between the up threshold and the down threshold.

Then, whether or not the bifurcation route tilt attribute 101 and the main road route tilt attribute 102 have a same tilt attribute is determined (step S3).

Then, in a case that the bifurcation route tilt attribute 101 and the main road route tilt attribute 102 have a same tilt attribute, the routing is defined as indeterminable between a bifurcation road (ramp) and a main road of an expressway to go on to step S16 and pass through the ramp section.

Meanwhile, in a case that the bifurcation route tilt attribute 101 and the main road route tilt attribute 102 have different tilt attributes, the tilt value detected by the pitch gyro sensor 3 is initialized (step S4).

The initialization of a tilt value includes initialization of a register in which the tilt value detected by the pitch gyro sensor 3 is stored.

In addition, in order to reduce influence due to variation in the amount of offset due to a change in the gravitational acceleration acting on the pitch gyro sensor 3 that is expressed for a short period, the initialization includes initialization in which a learned offset value that is learned from the measured values of the pitch gyro sensor 3 over the past tens of seconds is set as the amount of offset.

As the process of initializing the tilt value is finished, the pitch angle rate detected by the pitch gyro sensor 3 is obtained for every sampling period (step S5).

At this point, regarding the obtained pitch angle rate, an offset elimination process is carried out by the offset elimination circuit 19 in the tilt calculation unit 6 using the learned offset value thus learned as the amount of offset.

In addition, in the tilt calculation unit 6, correction of the pitch angle rate detected by the pitch gyro sensor 3 is carried out by the pitch angle correction mechanism 17 using the angle of mounting the navigation system 30 detected by the mounting angle detection unit 9.

Then, a tilt angle in front and rear of the vehicle is calculated by moving averaging or integrating the pitch angle rate obtained for every sampling period with reference to a certain driving distance (step S6).

As a result, when the tilt angle in front and rear of the vehicle thus moving averaged or integrated is determined as below the down threshold for determination of downward inclination, the tilt attribute determination mechanism 31 determines that the road on which the own vehicle is currently driving is downwardly inclined (step S9).

When the tilt angle in front and rear of the vehicle thus integrated is determined as over the up threshold for determination of upward inclination, the tilt attribute determination mechanism 31 determines that the road on which the own vehicle is currently driving is upwardly inclined (step S8).

When the tilt angle in front and rear of the vehicle thus integrated is determined as in between the up threshold and the down threshold, i.e., more than the down threshold and less than the up threshold, whether or not a ramp section is passed through is determined (step S19).

Then, it goes back to step S5, when determined that a ramp section is not passed through, to go on to the processes in steps S5, S6, and S7.

It is determined that the state of the integrated tilt angle in front and rear of the vehicle is continuously in between the up threshold and the down threshold in step S7, and a ramp section is passed through in step S19 that follows. In this case, the tilt attribute determination mechanism 31 determines that the road on which the own vehicle is currently driving is horizontal.

That is, when the state of the integrated tilt angle being in between the up threshold and the down threshold is continued until passing through a ramp section, the road on which the own vehicle is currently being driven is determined as horizontal (level) (step S10).

In such a manner, the tilt attribute 103 of the road currently driving on is determined as “downward inclination”, “upward inclination”, or “horizontal” in the tilt attribute determination mechanism 31 of the tilt calculation unit 6.

Subsequently, the vehicle route determination mechanism 32 of the tilt calculation unit 6 refers to the table TBL based on the bifurcation route tilt attribute 101 and the main road route tilt attribute 102 obtained in step S2 and the tilt attribute 103 determined in the tilt attribute determination mechanism 31 (step S11).

Then, the road currently driving on is determined whether a bifurcation road or a main road (steps S12, S13, and S15).

For example, while the current location of the own vehicle has entered into a ramp section, the bifurcation route tilt attribute 101 and the main road route tilt attribute 102, on the map data, of the road currently driving on obtained in step S2 are supposed to be upwardly inclined “UP” and horizontal “HORIZONTAL”, respectively.

In such a case, when the tilt attribute 103 determined in step S7 is upwardly inclined “UP”, the road currently driving on is determined to be a bifurcation road (ramp) with reference to the table TBL.

Alternatively, in a case that the tilt attribute 103 determined in step S7 is horizontal “HORIZONTAL”, the road currently driving on is determined to be “not passing”, i.e., driven on a main road with reference to the table TBL.

Still alternatively, in a case that the tilt attribute 103 determined in step S7 is downwardly inclined “DOWN”, the road currently driving on is determined to be “not passing”, i.e., driven on a main road with reference to the table TBL.

In such a manner, since whether the road on which the own vehicle is currently driving is a bifurcation road (ramp) or a main road is determined from the tilt attributes, data is processed quickly and the determination result is obtained immediately.

As the determination result of whether the road currently driving on is a bifurcation road (ramp) or a main road is obtained in the vehicle route determination mechanism 32, the tilt calculation unit 6 informs the navigation unit 11 of the determination result (step S14). The navigation unit 11 displays the current location of the own vehicle on the display unit 12 based on the determination result.

In this case, the navigation unit 11 display outputs the current location of the currently driving own vehicle on a bifurcation road (ramp) or a main road of an expressway on the map data based on the determination result informed by the tilt calculation unit 6.

Then, the obtained determination result is maintained until the current location of the own vehicle goes out of the ramp section (step S16).

According to this embodiment, while the current location of the own vehicle is in a ramp section, the bifurcation route tilt attribute 101 of a bifurcation road (ramp) in the ramp section and the main road route tilt attribute 102 of a main road of an expressway from which the bifurcation road is bifurcated are read out from the memory unit 13.

Then, the table TBL in which the determination result 104 is set corresponding to the bifurcation route tilt attribute 101, the main road route tilt attribute 102, and the determined tilt attribute 103 is referred to based on the tilt attribute 103, the bifurcation route tilt attribute 101, and the main road route tilt attribute 102. Then, the determination result 104 is obtained whether the road currently driving on is a bifurcation road (ramp) or a main road.

In such a manner, since whether the road currently driving on is a bifurcation road (ramp) or a main road is determined utilizing the table TBL by the tilt attributes, there is an effect to be capable of providing a method and a system of determining a vehicle route in which data is processed quickly and the determination result is obtained immediately.

In addition, there is also an effect to be capable of providing a method and a system of determining a vehicle route in which correction of a guided route can be carried out quickly when driven in a route different from the guided route in routes running in parallel or the like.

The present application contains subject matter related to that disclosed in Japanese Priority Patent Application JP 2009-185940 filed in the Japan Patent Office on Aug. 10, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method of determining a vehicle route, comprising the steps of:
calculating a current location to calculate current location information based on signals from a plurality of GPS satellites;
memorizing ramp section definition information to define a ramp section having a bifurcation structure including both a main road route and a bifurcation route bifurcated from the main road route, a main road route tilt attribute representing whether the main road route in the ramp section is upwardly inclined, downwardly inclined, or horizontal, and a bifurcation route tilt attribute representing whether the bifurcation route in the ramp section is upwardly inclined, downwardly inclined, or horizontal in a memory unit;
ramp section determining whether or not the current location of a vehicle has entered into the ramp section based on the current location information;
detecting pitch angle rate information of the vehicle, by a sensor;
determining a tilt attribute of a route on which the vehicle is driving to be whether upwardly inclined, downwardly inclined, or horizontal by sampling the pitch angle rate information detected by the sensor in the pitch angle rate information detection step in a predetermined sampling period for integration;
table defining to define, as a table, a route determination result of the route on which the vehicle is driving to be whether the main road route or the bifurcation route in correspondence with the tilt attribute of where the vehicle is driving determined by the tilt attribute determination step, the main road route tilt attribute in the ramp section, and the bifurcation route tilt attribute in the ramp section; and
determining a vehicle route to obtain the route determination result of whether the route on which the vehicle is driving is the main road route or the bifurcation route with reference to the table based on the main road route tilt attribute, the bifurcation route tilt attribute, and the tilt attribute.

2. A navigation apparatus, comprising:
a GPS process unit calculating current location information based on signals from a plurality of GPS satellites;
a memory unit memorizing ramp section definition information to define a ramp section having a bifurcation structure including both a main road route and a bifurcation route bifurcated from the main road route, a main road route tilt attribute representing whether the main road route in the ramp section is upwardly inclined, downwardly inclined, or horizontal, and a bifurcation route tilt attribute representing whether the bifurcation route in the ramp section is upwardly inclined, downwardly inclined, or horizontal;
ramp section determination means for determining whether or not a current location of a vehicle has entered into the ramp section based on the current location information;
a sensor outputting pitch angle rate information of the vehicle;
tilt attribute determination means for determining a tilt attribute of a route on which the vehicle is driving to be whether upwardly inclined, downwardly inclined, or horizontal by detecting the pitch angle rate information outputted from the sensor in a predetermined sampling period;
a table defining a route determination result of the route on which the vehicle is driving to be whether the main road route or the bifurcation route in correspondence with the tilt attribute of where the vehicle is driving determined by the tilt attribute determination means, the main road route tilt attribute in the ramp section, and the bifurcation route tilt attribute in the ramp section; and
vehicle route determination means for obtaining the route determination result of whether the route on which the vehicle is driving is the main road route or the bifurcation route with reference to the table based on the main road route tilt attribute, the bifurcation route tilt attribute, and the tilt attribute.

3. The navigation apparatus according to claim 2, wherein the sensor is a pitch gyro sensor utilizing a gyroscope.

4. The navigation apparatus according to claim 2, further comprising pitch angle rate correction means for correcting the pitch angle rate information detected by the sensor in accordance with a mounting angle of the navigation system with reference to a direction of the vehicle going straight ahead.

5. The navigation apparatus according to claim 2, further comprising an offset elimination circuit eliminating offset of the pitch angle rate information detected by the sensor.

6. The navigation apparatus according to claim 2, further comprising:
an acceleration sensor detecting acceleration information of the vehicle in a direction of travel;
an orientation sensor detecting orientation angle information of the vehicle in a direction of travel;
a plane speed calculation unit calculating a vehicle speed on a plane based on the acceleration information of the vehicle in the direction of travel detected by the acceleration sensor and the orientation angle information of the vehicle in the direction of travel detected by the orientation sensor; and
a plane location calculation unit calculating a current location of the vehicle on map data based on the vehicle speed on the plane calculated by the plane speed calculation unit.

7. A navigation apparatus, comprising:
a GPS process unit calculating current location information based on signals from a plurality of GPS satellites;
a memory unit memorizing ramp section definition information to define a ramp section having a bifurcation structure including both a main road route and, a bifurcation route bifurcated from the main road route, a main road route tilt attribute representing whether the main road route in the ramp section is upwardly inclined, downwardly inclined, or horizontal, and a bifurcation route tilt attribute representing whether the bifurcation route in the ramp section is upwardly inclined, downwardly inclined, or horizontal;
a ramp section determination mechanism determining whether or not a current location of a vehicle has entered into the ramp section based on the current location information;
a sensor outputting pitch angle rate information of the vehicle;
a tilt attribute determination mechanism determining a tilt attribute of a route on which the vehicle is driving to be whether upwardly inclined, downwardly inclined, or horizontal by detecting the pitch angle rate information outputted from the sensor in a predetermined sampling period;
a table defining a route determination result of the route on which the vehicle is driving to be whether the main road route or the bifurcation route in correspondence with the tilt attribute of where the vehicle is driving determined by the tilt attribute determination mechanism, the main road route tilt attribute in the ramp section, and the bifurcation route tilt attribute in the ramp section; and
a vehicle route determination mechanism obtaining the route determination result of whether the route on which the vehicle is driving is the main road route or the bifurcation route with reference to the table based on the main road route tilt attribute, the bifurcation route tilt attribute, and the tilt attribute.
